(19) United States
(12) Patent Application Publication
(10) Pub. No.: US 2015/0020154 A1
(43) Pub. Date: Jan. 15, 2015

(54) ANONYMOUS COUPLING PLATFORM METHOD AND SYSTEM

(71) Applicants: Daniel SETTON, Ramat Gan (IL); Baruch Mor, Har Adar (IL); Yaakov Shasha, Petach Tikva (IL)

(72) Inventors: Daniel SETTON, Ramat Gan (IL); Baruch Mor, Har Adar (IL); Yaakov Shasha, Petach Tikva (IL)

(21) Appl. No.: 14/326,489

(22) Filed: Jul. 9, 2014

Related U.S. Application Data
(60) Provisional application No. 61/844,518, filed on Jul. 10, 2013.

(51) Int. Cl. G06F 21/62; H04L 29/06

(52) U.S. Cl. CPC G06F 21/6254; H04L 63/08
USPC 726/2

(57) ABSTRACT

The subject matter discloses a system and methods for facilitating a platform for anonymous coupling via a computerized network. In some embodiments, the computerized network is an internet network. Such a platform enables a user to find a match with one or more other users according to profile definition without exposing his identity.

### FIELD OF THE INVENTION

The present disclosure relates to communication networks in general, and to systems for facilitating social networks, in particular.

### BACKGROUND OF THE INVENTION

Social network platforms enable a plurality of users to share data related to their personal life or any other data. Typically, the data includes pictures of the user and details about the user. Such social network platforms facilitate means, such as chat, for enabling the communication between the users.

### BRIEF SUMMARY OF THE INVENTION

One exemplary embodiment of the disclosed subject matter is a method for anonymous coupling, the method comprising: associating in a first data repository, a profile of a first user with an impersonal identification of the first user; wherein the profile of the first user comprises an at least one first characteristic, providing to a second data repository, the impersonal identification of the first user; the providing being for associating the impersonal identification with a communication address in the second data repository; receiving, from a computerized device of a second user, a request for anonymous coupling; wherein the request comprising a queried profile, comparing the first profile with the second profile; retrieving from the first data repository the impersonal identification associated with the first profile as a result of identifying the first profile being substantially identical with the second profile; and providing to the second data repository the impersonal identification; the providing being for retrieving from the second data repository the communication address associated with the impersonal identification for utilizing the communication address for establishing a communication session between the first user and the second user; wherein an identity of the first user cannot be detected by the impersonal identification; thereby preventing a non authorized user the identification of the first user according to the first characteristic.

According to some embodiments the communication device is a cellular telephone. According to some embodiments the impersonal identification is one member of a group consisting of a hash value, a random number, a serial number and a random string. According to some embodiments the first profile comprises a hash tag. According to some embodiments the at least one first characteristic comprises a free text. According to some embodiments the step of identifying the first profile is substantially identical with the second profile. According to some embodiments the communication address is associated with an IP address and a telephone number. According to some embodiments the first data repository and the second data repository are separated. According to some embodiments the method comprises the step of receiving a registration request from a first computerized device of the first user, wherein the registration request comprises the first profile of the first user.

One other exemplary embodiment of the disclosed subject matter is a method for coupling, the method comprising: receiving from a computerized device of a first user a request for coupling with a second user; the request comprising a queried profile; returning to the computerized device at least one unmatched profile; wherein the at least one unmatched profile being associated with a second user; wherein the second user being associated with an at least one denied matching request; and establishing a communication session between the first user to and the second user as a result of a request for coupling from the first user. According to some embodiments the method further comprising transmitting the unmatched profile to a third user as a result of receiving a request for the transmitting from the first user.

One other exemplary embodiment of the disclosed subject matter is a computer program product for anonymous coupling, the computer program product comprising: a computer readable storage medium having encoded thereon: first program instructions executable by a computer to cause the computer to associate in a first data repository, a profile of a first user with an impersonal identification of the first user; wherein the profile of the first user comprises an at least one first characteristic, second program instructions executable by a computer to cause the computer to provide to a second data repository the impersonal identification of the first user; the providing step is for associating the impersonal identification with a communication address in the second data repository; third program instructions executable by a computer to cause the computer to receive, from a computerized device of a second user, a request for anonymous coupling; wherein the request comprising a queried profile, fourth program instructions executable by a computer to cause the computer to compare the first profile with the second profile; fifth program instructions executable by a computer to cause the computer to retrieve from the first data repository the impersonal identification associated with the first profile as a result of identifying the first profile being substantially identical with the second profile; and sixth program instructions executable by a computer to cause the computer to provide to the second data repository the impersonal identification; the providing being for retrieving from the second data repository the communication address associated with the impersonal identification for utilizing the communication address for establishing a communication session between the first user and the second user; wherein an identity of the first user cannot be detected by the impersonal identification; thereby preventing a non authorized user the identification of the first user according to the first characteristic.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a block diagram of a system for anonymous coupling, in accordance with some exemplary embodiments of the subject matter;

FIG. 2 shows a flowchart diagram of a scenario of an anonymous communication, in accordance with some exemplary embodiments of the disclosed subject matter;

FIG. 3 shows a flowchart diagram of a scenario of separation the profile of the user from data that identifies the user, in accordance with some exemplary embodiments of the disclosed subject matter;

FIG. 4 shows a flowchart diagram of a scenario of registration to the system, in accordance with some exemplary embodiments of the disclosed subject matter;

FIG. 5 shows a flowchart diagram of a scenario of defining a profile, in accordance with some exemplary embodiments of the disclosed subject matter;

FIGS. 6A and 6B show a flowchart diagram of a method for coupling a user of an un-matched profile with another user, in accordance with some exemplary embodiments of the disclosed subject matter; and

FIGS. 7A 7B and 7C show a flowchart diagram of a method for anonymous coupling, in accordance with some exemplary embodiments of the disclosed subject matter.

### DETAILED DESCRIPTION

Social network platforms typically archive and display data that identifies the users of the social network, such data include, for example name of the user, pictures of the user, name of friends etc.

However, there is a need for a social network platform that will enable anonymous coupling between users according to characteristic defined by the users. For example, a person who suffers from a disease may wish to communicate via the internet network with other people with the same disease or with experts without identifying himself. In another example, a person under drug or alcoholic rehabilitation would like to contact other people in the same status in order to get emotional support. Such users would like to communicate with other users with the same profile without exposing their identity.

There is also a need for a social network platform that will enable to identify a profile and to search a profile by using free text.

Embodiments of the present invention disclose a system and methods for facilitating a platform for anonymous coupling via a computerized network. In some embodiments, the computerized network is an internet network. Such a platform enables a user to find a match with one or more other users according to profile definition without exposing his identity. By an anonymous coupling is meant that the profile of the user is not associated with any data that identifies the user; Thus, the profile of the user is not displayed with information that identifies the user and more than that, the profile of the user is associated in the data base with impersonal identification only. That is to say, the profile is associated with an impersonal identification that cannot identify the user. The profile is not associated with data that can identify the user. Such data may be, for example, user name, user address, telephone number, a photo of the user, an identification of a device of the user, IP address or any other address that is used for communicating with the user, history of activity in the network, and the like. Such an impersonal identification can be used for retrieving the profile of the user in the data base; however, such an impersonal identification cannot be used for identifying the user. In some embodiments, information that may identify the user is associated with the impersonal identification in a second data repository. The second data repository is separated from the first data repository. For example, the second data repository may be in a separate computerized device and/or in a separate network and/or in a different location. Thus, a hacker or any other non authorized person cannot associate personal identification of the user with the profile of the user.

The profile may include free text. The free text may include hash tags. That is to say, a first user may define his profile by using free text and a second user may define a query profile by using free text. Such a free text is not limiting as oppose to a profile that is composed of predefined words only and enables to define any profile.

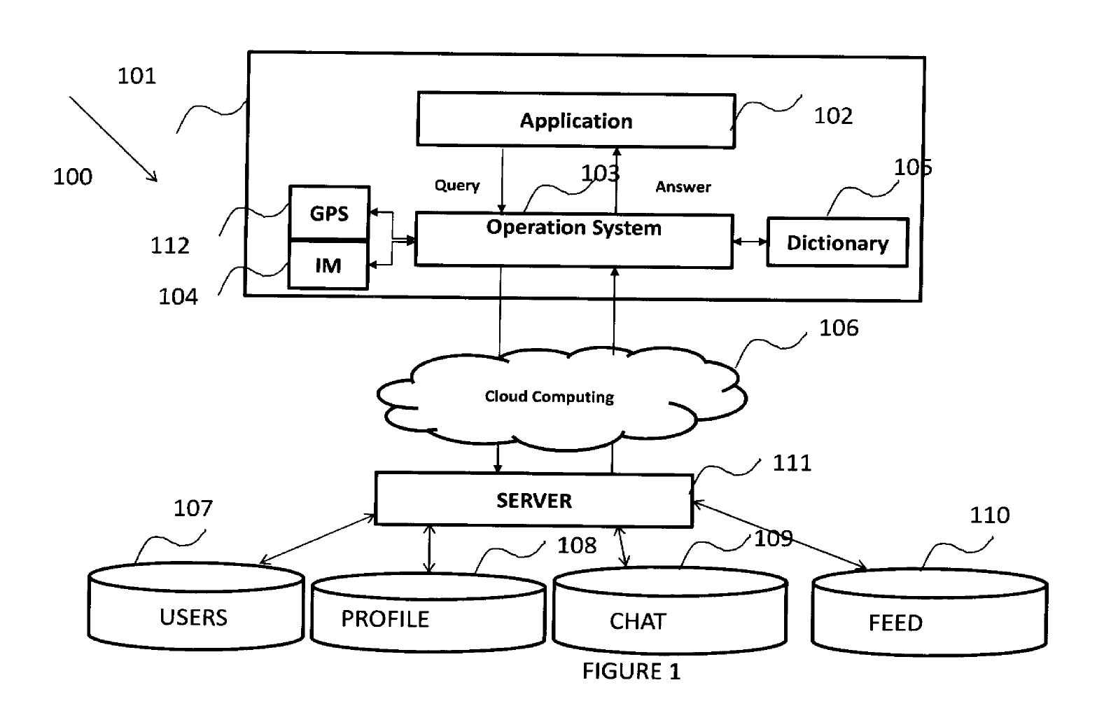

Referring now to FIG. 1 showing a block diagram of a system for anonymous coupling, in accordance with some exemplary embodiments of the subject matter.

System 100 comprises communication devices 101, a server 111, 107, profile data base 108, chat database 109 and feed data base 110. In some embodiments, the system 100 also includes user data base.

The communication device 101 may be a cellular telephone, a laptop, a tablet or any other device from which the user can register in the system and communicates with other users. Each of the communication devices 101 includes an application 102, an operating system 103, a dictionary 105, GPS 112 and Instant Messaging module 104.

The application 102 provides user interface for registration to the system and for communicating with other users. The application 102 may be downloaded to the communication device 101. The application 102 communicates with the operating system 103 by queering the operating system 103 to activate commands such as registration, searching for users having a certain profile and chatting with one or more users that were found in a search.

The operating system 103 can be of any type. An example of an operating system is Android. The operating system 103 communicates with the server for storing the profile of the users in the profile data base 108, for retrieving profiles from the profile data base 108 and for chatting through the chat database 109.

The GPS 112 is adapted for retrieving the location of the user. The location may be used for sorting the list of profiles that are found in the query according to vicinity to location, such that the profile of the nearest users is presented in the top of the list.

The Instant Messaging module 104 is configured for providing the chat. The chat may be activated by choosing one of the profiles.

The server 111 is configured for receiving and handling registration requests and coupling requests from a plurality of users.

The user data base 107 is configured for storing the communication address of the users with the impersonal identifications of the users. The communication address may include IP address, which is used for establishing a communication session with the user.

The profile data base 108 is configured for storing the impersonal identifications of the users associated with the profiles of the users.

The chat database 109 is configured for storing the content of the chats associated with the impersonal identification of the participating in the chats.

The feed data base 110 is configured for storing profiles of users that could not find a match. The profiles are associated with impersonal identification of the users.

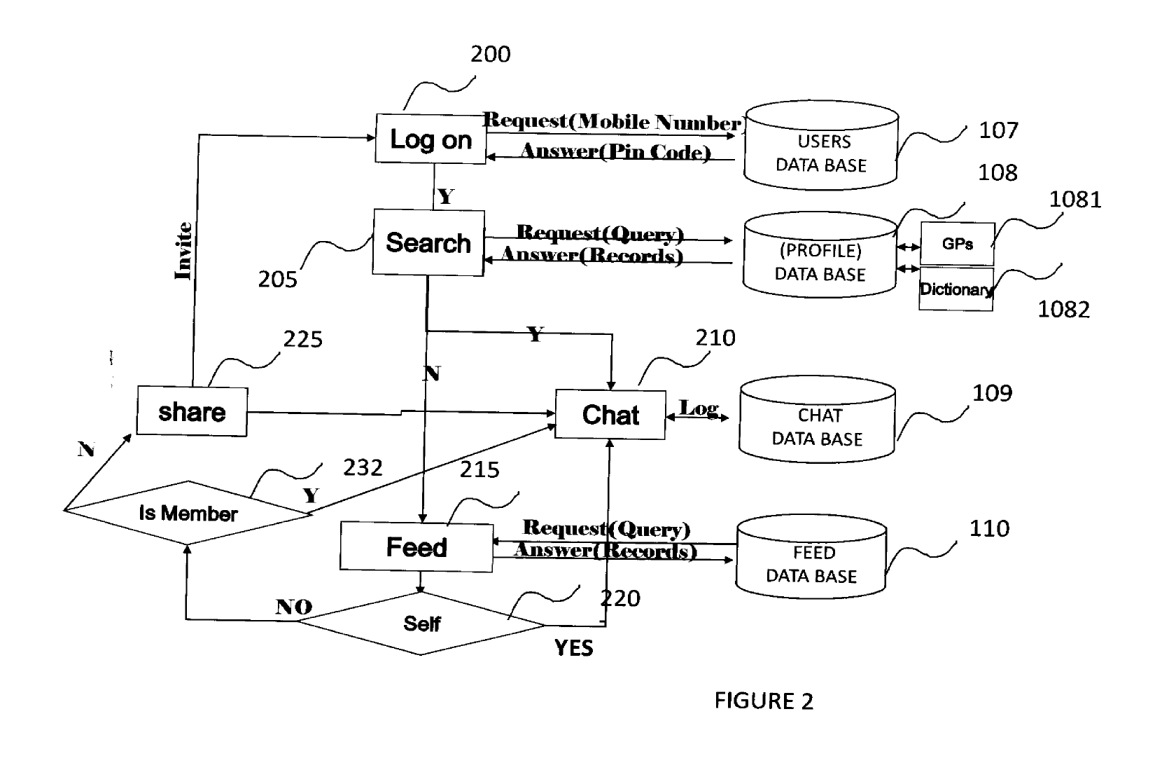

FIG. 2 shows a flowchart diagram of a scenario of an anonymous communication, in accordance with some exemplary embodiments of the disclosed subject matter.

At 200, the user logs in to the application. The user logs in with his mobile number and receives a pin code. The pin code is used as a password for entering the application.

At 205, the user enters a queried profile and queries for a list of anonymous users having this queried profile. The queried profile is a profile of a person with whom the user would like to couple. The request is transferred to the server via the operating system. The search engine of server fetches the list of substantially similar profiles from the profile data base. The search engine of the server may use a dictionary 1082 and GPS 1081 for finding synonyms for the expression that is defined in the profile.

At 210, which is performed if a match was found with an at least one profile, the selected profiles are displayed to the user. It should be noted that only the profiles are displayed without revealing any personal data of the other user. In some embodiments the profiles are sorted in the displayed list according to their proximity to the location of the user. In some embodiments, the profiles are sorted according to the similarity to the queried profile. The similarity may be calculated according to number of similar characteristics. In some embodiments, the profiles are sorted according a combination of a similarity and proximity. The user selects a profile and starts a chat session with the other user to which the selected profile belongs. The chat may be recorded in the chat data base 109.

At 215, which is performed if no match was found in the search; the user is provided with an option to find a match from a list of profiles of other users who did not find a match. In some cases, the user may find a match with other people having a profile that is not related to the profile that was searched by the user and are waiting for a match. For example, the user may initially like to communicate with diabetics, however if he cannot find another user having a profile that is associated with diabetic, the user may still find an interest in users with a profile related to classical music who are waiting for a match. The list of such profiles is retrieved from the feed database 110.
At, 220 the system checks if the user selected a profile from the list of un matched profiles.

If the user selected a profile then, at 210, the chat session with the user of the selected profile is initiated.

If the user did not select a profile then, the user is offered to share one of the profiles from the feed list with another person.

If the user chooses to share one of the profiles from the feed list with another person, then the user enters the telephone number or any other personal identification of the other person.

At 232 the system checks, in the user data base, if this person is already a member.

If the person is already a member then an invitation to chat is sent to the other person and, if the person chooses one profile, a chat session is initiated at 210.

Otherwise, (the person is not a member), at 225 the person is invited to share the application, for example by sending an automatic SMS and, at 210, the person selects one profile and a chat session is initiated.

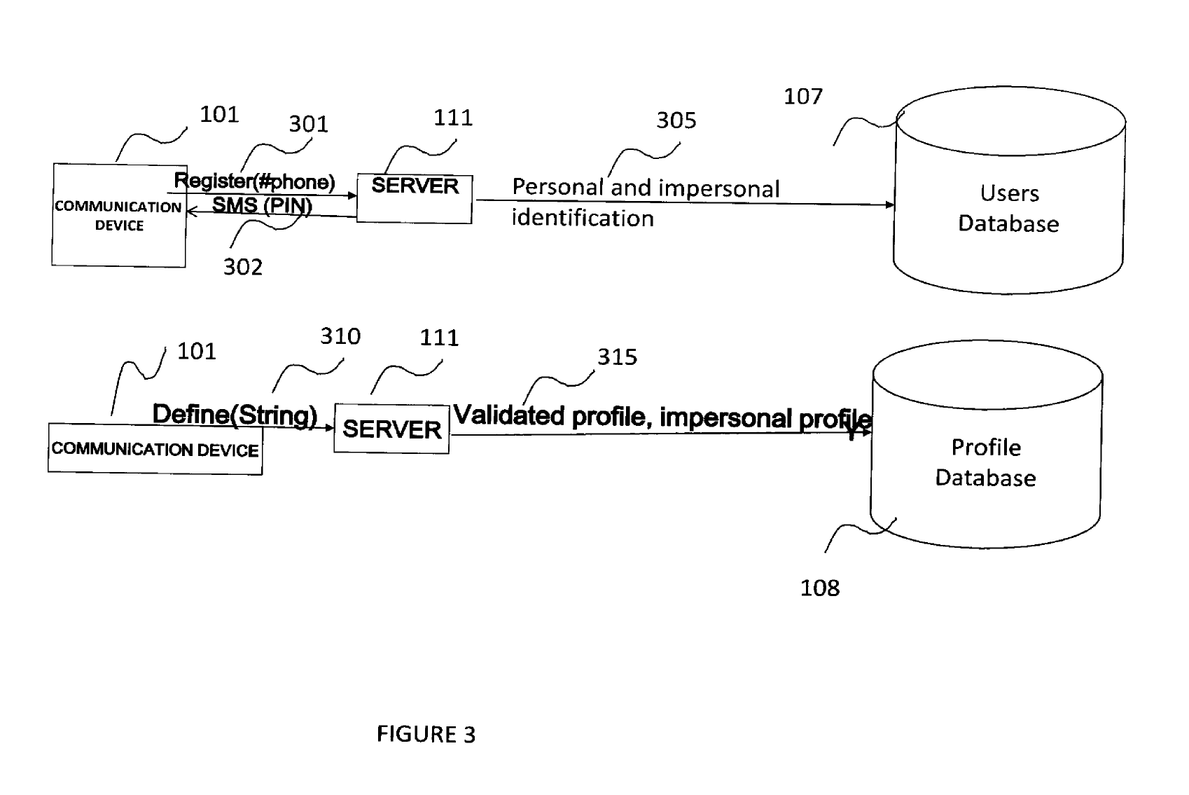

FIG. 3 shows a flowchart diagram of a scenario of separation the profile of the user from data that identifies the user, in accordance with some exemplary embodiments of the disclosed subject matter.

At 301, the user registers in the system via an application installed in his cellular telephone 101. The application sends the telephone number of the user to the server 111.

At 302, the server 111 returns a pin number to the application. The pin number is used as a password for accessing the system.

At 305, the server 111 generates an impersonal identification. The impersonal identification is an identification, which enables to retrieve data related to the user from the data base. The impersonal identification cannot reveal or identify the user, as opposed to a personal identification such as a telephone number. Examples of such impersonal identifications are a sequential number, a random number, a hash value and the like.

The server 111 stores the impersonal identification, which is associated with the personal identification in the user's database 107. In some embodiments, the location of the user is also associated with the impersonal identification in the user's data base.

At 310, the user generates a profile. In some embodiments, the profile is a string of characters. The profile typically includes one or more characteristics of the user. The profile is sent to the server 111.

At 315, the server validates the profile. The validation includes validation of the length of the profile, validation that there are no forbidden words and validation of hash tags. The server stores the validated profile and the impersonal identification in the profile database 108.

The validated profile is associated with the impersonal identification in the profile database 108. When another user is searching, via his communication device, for a user having a profile that is substantially identical to the validated profile, the system sends the validated profile and the impersonal identification to the communication device of the other user. The validated profile is displayed to the other user. If the other user chooses this validated profile, a communication session (such as a chat session) is established.

In some other embodiments, the system does not use any personal identification at all. In such a case, the user sends a request to register to the system without identifying himself. The system generates an impersonal identification, which is associated with the profile of the user. In such a case, the impersonal identification may be used by the user for accessing the system.

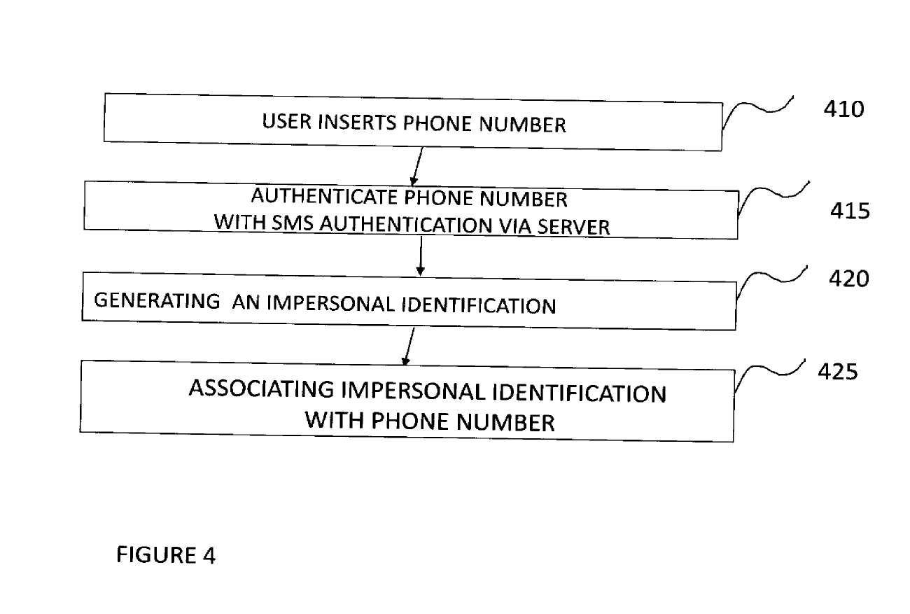

FIG. 4 shows a flowchart diagram of a scenario of registration to the system.

At 410, the user inserts a personal identification. In one example, the personal identification is the cellular telephone number. The personal identification enables the system to contact the user; for example, in a case of mal usage of the system.

At 415, the server authenticates the telephone number by, for example, an SMS message which includes a PIN code.

At 420, an impersonal identification is generated. Examples of impersonal identification are a sequential number, a random number and a hash result of the telephone number

At 425, the impersonal identification and the telephone number are associated and stored in the data base. In some embodiments, the location of the user is also associated with the impersonal identification and is stored in the data base.

In some other embodiments, the system does not use any personal identification at all. In such a case, the user sends a request to register to the system without identifying himself. The system generates an impersonal identification, which is associated with the profile of the user. In such a case the impersonal identification may be used by the user for accessing the system.

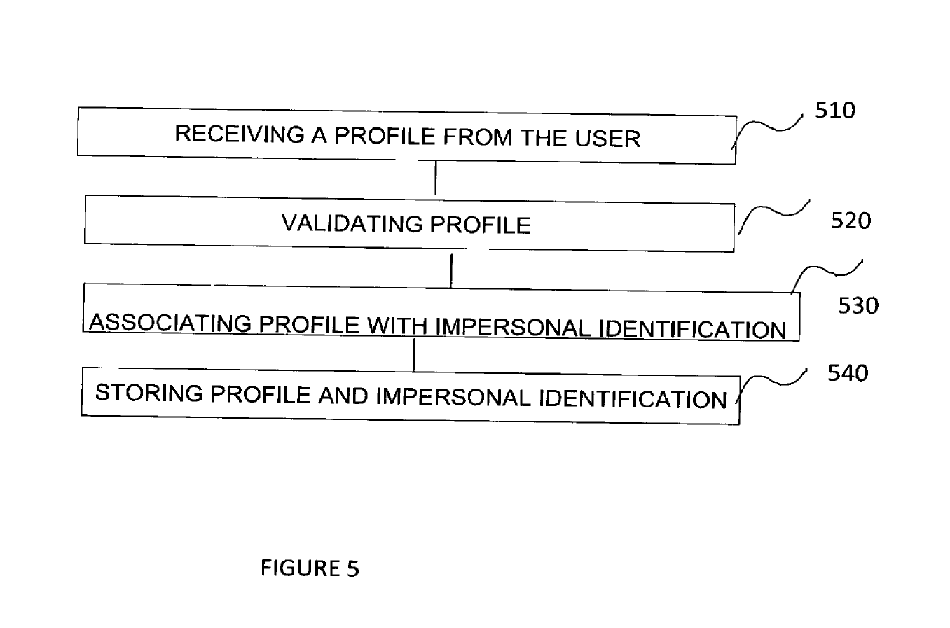

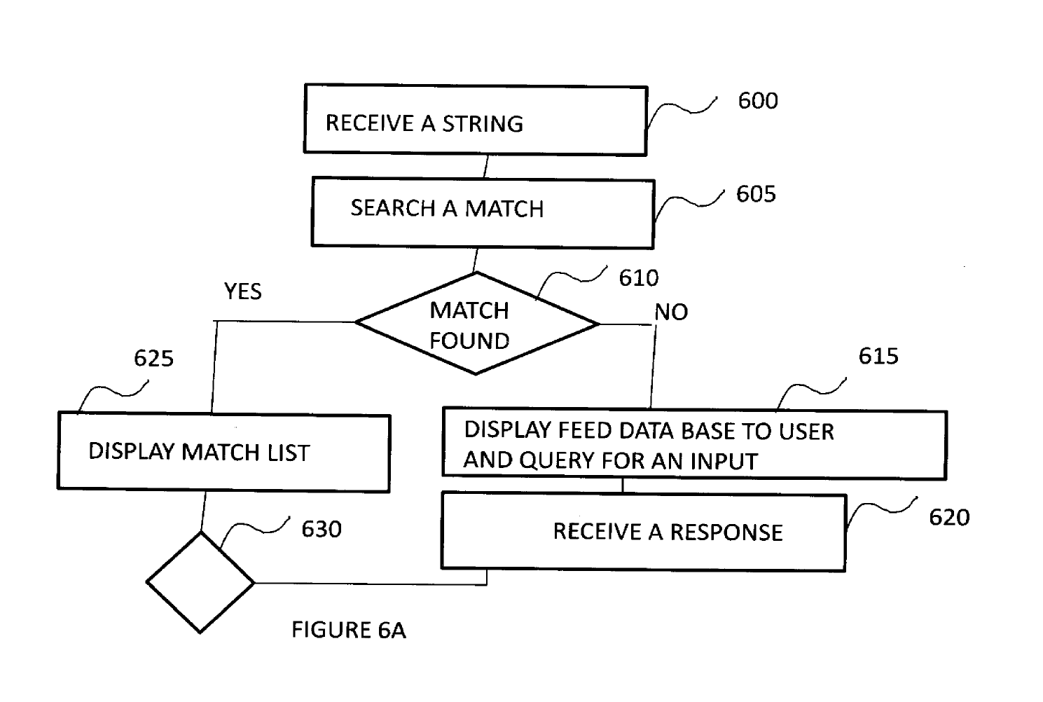

FIG. 5 shows a flowchart diagram of a scenario of defining a profile.

At 510, a profile is received from the user. In some embodiments the profile includes words and hash tags. A hash tag is a word or a phrase prefixed with the symbol “#” to label groups and topics. The hash tags and the words typically define characteristic of the user.

At 520, the profile is validated. Validating the profile includes validating that the length of the profile does not exceed a certain threshold, validating that the profile does not include forbidden words, and validating hashtags.

At 530, the profile is associated with the impersonal identification of the user. The profile is not associated with a personal identification in order to prevent attackers or any unauthorized person to identify the person to which the profile belongs.

At 540, the associated profile and impersonal identification is stored in the profile data base. When another user is looking for a profile that matches his characteristic, the saved profile is compared with the other person's profile. If a match is found the associated impersonal identification is retrieved.

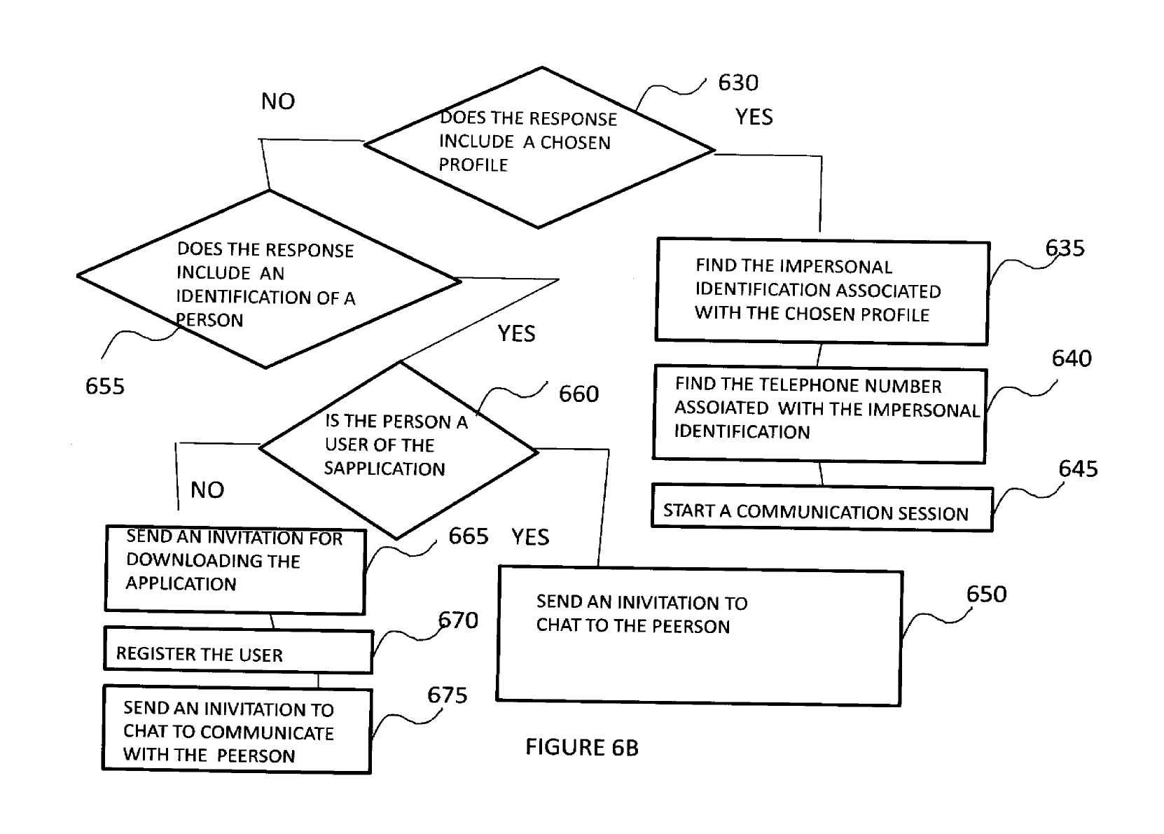

FIGS. 6A and 6B show a flowchart diagram of a method for associating a user of an un-matched profile with another user, in accordance with some exemplary embodiments of the disclosed subject matter.

In some cases, a user does not find a match to his request, in such cases the user is offered to communicate with other users who did not find a match. The user, then, can select to communicate with one of one of the users of these profiles or to offer a friend to communicate with this person.

At 600, a queried profile is received from a user. In some embodiments the queried profile includes text and hash tags. In some embodiments the queried profile includes an at least one characteristic.

At 605, the server searches in the profile data base for a profile that is substantially identical to the queried profile.

At 610, the server checks if there was a match.

If there was a match then at 625, the list of profiles that matched the queried profile is displayed to the user in order to enable the user to communicate with one of the members from the list.

If there was no match then at 615, the profiles from the feed data base are displayed to the user and the user is offered to choose one of the profiles.

At 620, the server receives a response from the user.

If there was a match then at 625 the server displays the match list.

At 630, the server checks if the response includes a profile from the list.

Blocks 635, 640 and 645 are performed if the response includes a profile. In such a case the user is interested to communicate with the member who owns the chosen profile.

At 635, the server finds the impersonal identification associated with the chosen profile. The impersonal identification is the identification that is associated, in the profile database, with the chosen profile.

At 640, the telephone number associated with the impersonal identification is found. The telephone number is retrieved from the user data base.

At 645, the system connects between the two users and the communication session is started.

Block 655 is performed if the response of the user does not include a chosen profile. At 655, the server checks if the response includes an identification of a person. Such a case occurs if the user does not find a match but would like to match a friend of him with a member that owns one of the profiles.

If the response includes an identification of a person then at 660 the server checks in the user data base if the person is a member of the application.

If the person is a member of the application, then at 650, the server sends him an invitation to communicate with the member to which the profile belongs. The invitation is sent with the profile and without exposing details about this member.

Blocks 65, 670 and 675 are performed if the user is not a member of the application.

At 665, the server sends an invitation to join the application. The invitation may include the profile that was chosen be the user.

At 670, a user response is received and the server registers the user to the system. The registration process is explained in greater detains in FIG. 4.

At 675, the profile is displayed to the person such that the person can click on the profile and start a communication session (for example chat) with the profile owner.

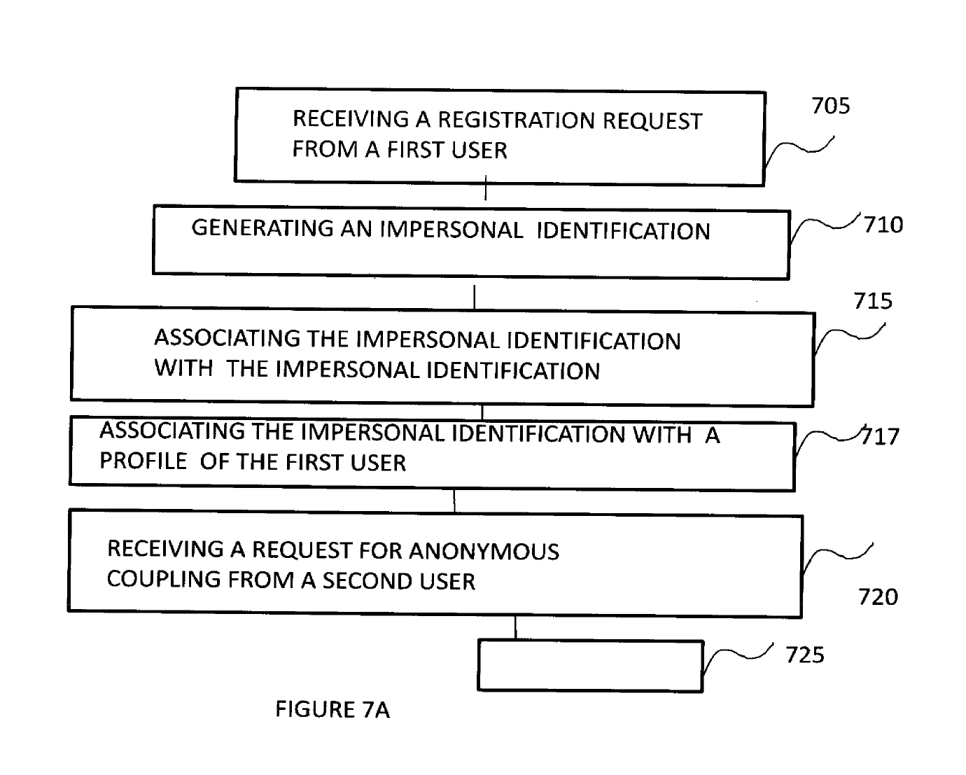

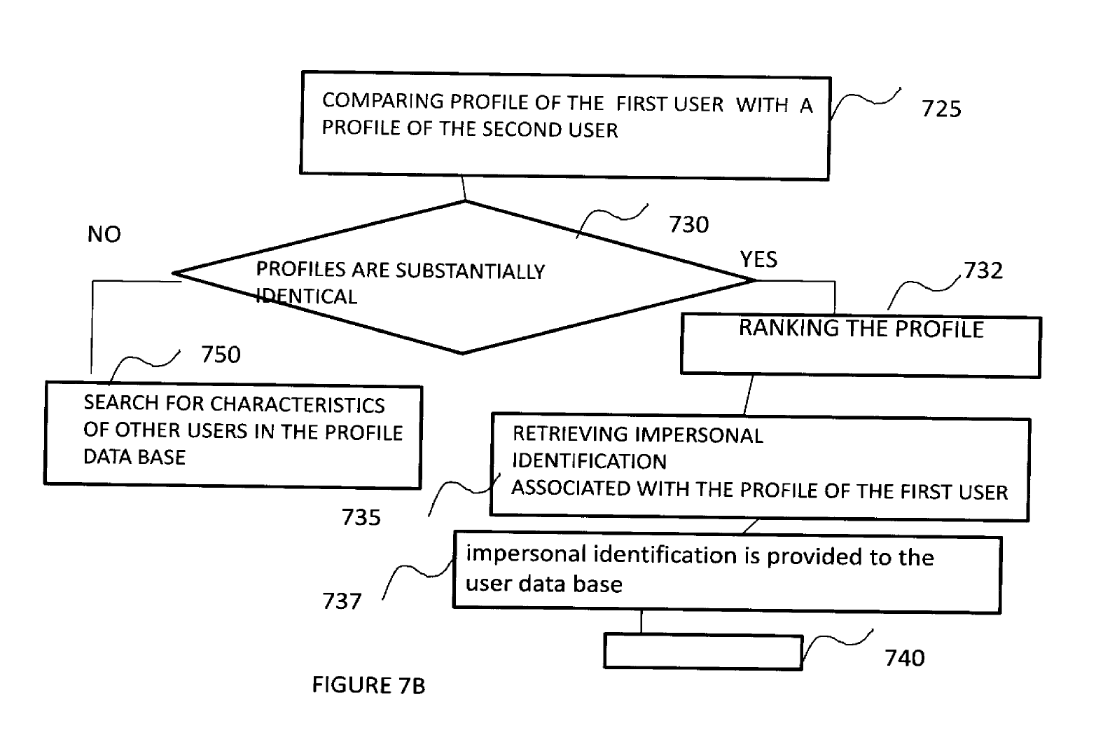

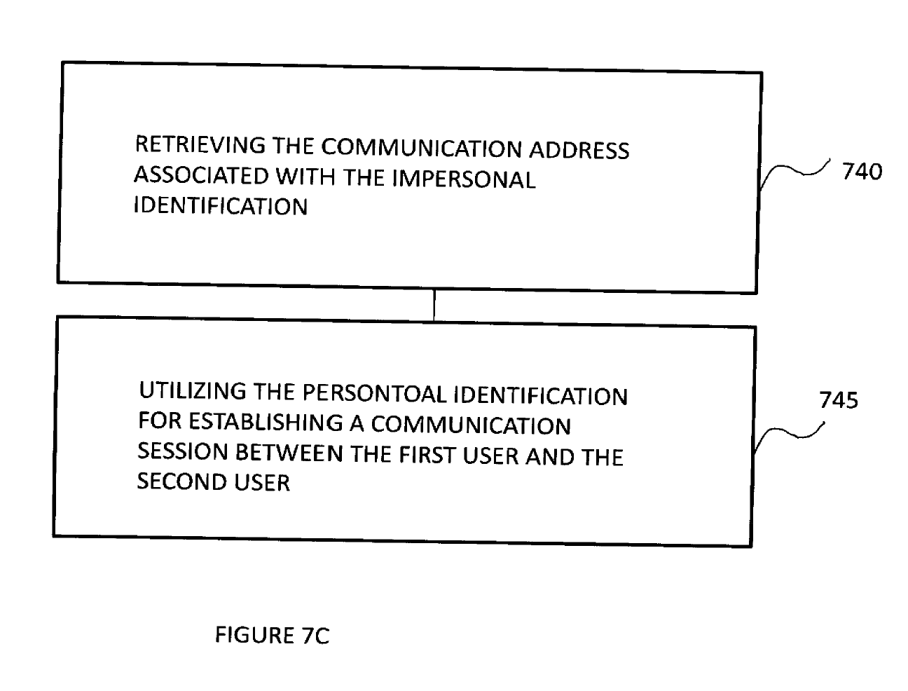

FIGS. 7A, 7B and 7C show a flowchart diagram of a method for anonymous coupling, in accordance with some exemplary embodiments of the disclosed subject matter.

At 705, a registration request is received. The registration request is sent from the communication device of the user. In one example, the registration request is sent from his mobile device. The registration request includes a profile.

The profile may be a text that includes characteristics. The characteristics may illustrate characters or hobbies or status of the user. An example of such a characteristic is an immigrant from a certain country. The characteristics may be provided in text wherein words are separated by a comma. In some embodiments the profile of the user is validated.

In some embodiments, the request includes a personal identification. The personal identification may be the telephone number of the user. The personal identification may be used for identifying the user. Thus, if there is a request of an authorized person to identify a user as a result of his activity (for example, as a result of mal chatting), the user may be identified by the personal identification.

At 710, an impersonal identification is generated such that an identity of the first user cannot be detected by the impersonal identification. Examples of impersonal identification are has value, random text and random number.

At 715, a communication address is associated with the impersonal identification and is kept in the users data base. The communication address may be an IP address or any other that is used for establishing a communication with the user; thus, a non authorized user can not retrieve any data related to the user (such as the chats associated with the user or his profile). In some cases the communication address is removed from the data base when the user exits the application for impersonal communication and the communication address is updated whenever the user enters the application.

At 717, the impersonal identification is associated with the profile and is saved in the profile data base.

At 720, a request for anonymous coupling is received, the request includes queried profile. The queried profile includes characteristics.

At 725, a search is performed in the profile data base. During the search characteristics of the queried profile are compared to characteristics of the profile of the registered user. The comparing process may utilize a synonym dictionary and spelling correction tool. Such a spelling correction tool may be an operation system spelling corrections tools. In some embodiments the data base is an SQL data base and the search is performed by utilizing SQL queries.

At 730 the server decides if the profile of the user is substantially identical with the queried profile. In some embodiment the profiles are substantially identical if an at least one characteristic of the user profile is substantially identical with an at least one characteristic of the queried profile. The characteristic may be a word separated by any separation characters such as a comma. The characteristic may also be a hash tag. In some embodiments the characteristics are substantially identical if they are either identical or one characteristic is identical to a synonym of the other characteristic or if one characteristic is identical to a spelling correction of the other characteristic.

Blocks 735, 740 and 745 are performed if the profile of the user is substantially identical with the queried characteristics.

At 732, the profile is ranked. In some embodiments the profile is ranked according to proximity to location of the user. In some embodiments the profile is ranked according to number of matched characteristics. In some embodiments the profile is ranked according to a combination of number of matched characteristics and proximity. The ranking may be utilized if there is more than one profile that matches the queried profile and there is a need to sort the profiles according to relevancy.

At 735, the impersonal identification that is associated with the profile of the user is retrieved from the profile data base.

At 737, the impersonal identification is provided to the user data base.

At 740, the communication address (e.g. IP address) that is associated with the retrieved impersonal identification is retrieved from the user data base.

At 745, the communication session between first user and second user is established.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for anonymous coupling, the method comprising:
associating in a first data repository, a profile of a first user with an impersonal identification of said first user; wherein said profile of said first user comprises an at least one first characteristic,
providing to a second data repository, said impersonal identification of said first user; said providing being for associating said impersonal identification with a communication address in said second data repository;
receiving, from a computerized device of a second user, a request for anonymous coupling; wherein said request comprising a queried profile,
comparing said first profile with said second profile;
retrieving from said first data repository said impersonal identification associated with said first profile as a result of identifying said first profile being substantially identical with said second profile; and
providing to said second data repository said impersonal identification; said providing being for retrieving from said second data repository said communication address associated with said impersonal identification for utilizing said communication address for establishing a communication session between said first user and said second user; wherein an identity of said first user cannot be detected by said impersonal identification; thereby preventing a non authorized user the identification of said first user according to said first characteristic.

2. The method of claim 1, wherein said communication device being a cellular telephone.

3. The method of claim 1, wherein said impersonal identification being one member of a group consisting of a hash value, a random number, a serial number and a random string.

4. The method of claim 1, wherein said first profile comprises a hash tag.

5. The method of claim 1, wherein said at least one first characteristic comprises a free text.

6. The method of claim 1, wherein said identifying said first profile being substantially identical with said second profile being as a result of identifying at least one first characteristic of said first profile being substantially identical with at least one characteristic of said queried profile.

7. The method of claim 1, wherein said communication address being one member of a group consisting of an IP address and a telephone number.

8. The method of claim 1, wherein said first data repository and said second data repository being separated.

9. The method of claim 1, further comprising receiving a registration request from a first computerized device of said first user, wherein said registration request comprises said first profile of said first user.

10. A method for coupling, the method comprising:
receiving from a computerized device of a first user a request for coupling with a second user; said request comprising a queried profile;
returning to said computerized device an at least one unmatched profile; wherein said at least one unmatched profile being associated with a second user; wherein said second user being associated with an at least one denied matching request; and
establishing a communication session between said first user to and said second user as a result of a request for coupling from said first user.

11. The method of claim 10, further comprising transmitting said unmatched profile to a third user as a result of receiving a request for said transmitting from said first user.

12. A computer program product for anonymous coupling, said computer program product comprising:
a computer readable storage medium having encoded thereon:
first program instructions executable by a computer to cause the computer to associate in a first data repository, a profile of a first user with an impersonal identification of said first user; wherein said profile of said first user comprises an at least one first characteristic,
second program instructions executable by a computer to cause the computer to provide to a second data repository said impersonal identification of said first user; said providing being for associating said impersonal identification with a communication address in said second data repository;
third program instructions executable by a computer to cause the computer to receive, from a computerized device of a second user, a request for anonymous coupling; wherein said request comprising a queried profile,
fourth program instructions executable by a computer to cause the computer to compare said first profile with said second profile;
fifth program instructions executable by a computer to cause the computer to retrieve from said first data repository said impersonal identification associated with said first profile as a result of identifying said first profile being substantially identical with said second profile; and
sixth program instructions executable by a computer to cause the computer to provide to said second data repository said impersonal identification; said providing being for retrieving from said second data repository said communication address associated with said impersonal identification for utilizing said communication address for establishing a communication session between said first user and said second user; wherein an identity of said first user cannot be detected by said impersonal identification; thereby preventing a non authorized user the identification of said first user according to said first characteristic.
